(19) United States
(12) Patent Application Publication
(10) Pub. No.: US 2026/0122615 A1
(43) Pub. Date: Apr. 30, 2026

(54) BAND SELECTION FOR MULTI-LINK SINGLE-RADIO USER EQUIPMENT BASED ON LINK USAGE CAPACITIES

(71) Applicant: Charter Communications Operating, LLC, St. Louis, MO (US)

(72) Inventors: Dileep Kumar Soma, Parker, CO (US); Pratiksha Shukla, Parker, CO (US)

(73) Assignee: Charter Communications Operating, LLC, St. Louis, MO (US)

(21) Appl. No.: 18/931,946

(22) Filed: Oct. 30, 2024

(51) Int. Cl. H04W 72/02; H04L 1/00; H04W 72/0453; H04W 72/52

(52) U.S. Cl. CPC H04W 72/02; H04L 1/0003; H04W 72/0453; H04W 72/52

(57) ABSTRACT

For user equipment (UE) that operates in a multi-link, single-radio (MLSR) mode, an access point (AP) of a (e.g., WiFi) local area network calculates link usage capacities (LUCs) for the different associated bands and performs comparisons based on those LUCs to the client traffic (CT) to select the band(s) to be used to transmit that CT during the next communication session between the UE and the AP. For example, if at least one LUC is greater than CT, then the AP selects the band with the greatest LUC. Otherwise, if two times the LUCs are greater than CT for at least two bands, then the AP distributes CT to the bands proportionately and sequentially. Otherwise, the AP uses conventional spraying to select the band. This band-selection technique provides improved throughput compared to using only conventional spraying for band selection.

### BACKGROUND

### Field of the Disclosure

The present disclosure relates to local area networks (LANs) and, more specifically but not exclusively, to WiFi networks.

### Description of the Related Art

This section introduces aspects that may help facilitate a better understanding of the disclosure. Accordingly, the statements of this section are to be read in this light and are not to be understood as admissions about what is prior art or what is not prior art.

It is known for an access point (AP) in a WiFi network to be able to support communications with instances of wireless user equipment (UE) via different frequency bands (e.g., 2.4 GHz, 5 GHZ, and 6 GHz bands). In multi-link multi-radio (MLMR) mode, the AP can communicate with a UE in two or more bands simultaneously. In multi-link single-radio (MLSR) mode, the AP stays connected with a UE in two or more bands, but can communicate only in one band at any given time.

In Enhanced MLSR (eMLSR) mode, it is known for an AP to decide which band to select for communications with a UE using a conventional technique referred to as spraying. In spraying, when an AP has traffic to transmit to a given UE or vice versa, the AP determines the activity on the previously selected band for that given UE. If the band is not currently being used for communications with any other UE associated with the AP, then the AP retains the previous selection of that band for that given UE. If, however, the band is currently being used for another associated UE, then the AP selects a different band supported by that given UE. In downlink operations (i.e., AP to UE), the AP decides the traffic distribution in an opportunistic way, putting the traffic wherever available; otherwise, waiting and using the next available slot. In uplink operations, in case the channel is found busy, the UEs backoff for random durations determined by their backoff timers.

Unfortunately, the spraying technique can result in sub-optimal performance in terms of throughput for the given UE in the available bands due to band-switching delays and eMLSR overhead. For example, one simulated situation involved a first UE that is capable of communicating only in the 5 GHz band at a maximum rate of 1200 Mbps and a second UE that is capable of communicating in the 5 GHz band at a maximum rate of 970 Mbps and in the 6 GHZ band at a maximum rate of 970 Mbps. When spraying was used to select bands to use for situations in which only the second UE communicates, the effective bandwidth for the second UE was only 859 Mbps. Furthermore, when spraying was used to determine which band to use for situations in which both UEs communicate, the effective bandwidth for the first UE was only 800 Mbps and the effective bandwidth for the second UE was only 591 Mbps.

### SUMMARY

Problems in the prior art are addressed in accordance with the principles of the present disclosure by a new technique for selecting bands for communications between an AP and a UE in a WiFi network operating in the MLSR mode.

In at least one embodiment, the present disclosure is a method for selecting a band from at least a first band and a second band for communication between an access point (AP) and an instance of user equipment (UE). The method comprises the AP (i) generating a first link usage capacity (LUC) value for the first band; (ii) generating a second LUC value for the second band; (iii) performing one or more comparisons based on the first and second LUC values to a CT value corresponding to client traffic to be communicated in a communication session between the AP and the UE; (iv) selecting the band based on the one or more comparisons; and (v) using the selected band for the communication session.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a simplified hardware block diagram of an example WiFi network; and

FIG. 2 is a flow diagram of the processing performed by the AP of FIG. 1 according to certain embodiments.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

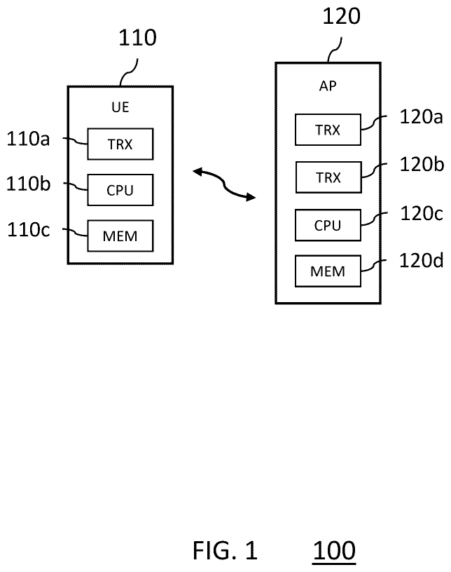

FIG. 1 is a simplified hardware block diagram of an example WiFi network 100 in which an instance of wireless user equipment (UE) 110 is located within the coverage area of an access point (AP) 120 of the network 100. Those skilled in the art will understand that there may be other UEs (not shown) within the coverage area of the AP 120 and that the AP 120 is connected to a backend communication system (not shown) that supports communication between the AP 120 and UEs within its coverage area as well as between the AP 120 and the outside world. In addition, although not shown in FIG. 1, the network 100 may have additional APs as well as other backend elements that support the functionality of the network 100 for communicating with multiple other UEs.

As shown in FIG. 1, the UE 110 includes (i) a wireless transceiver (TRX) 110a for transmitting wireless signals to and receiving wireless signals from the AP 120 and (ii) one or more processors (e.g., CPU and/or GPU microprocessors) 110b for controlling the operations of the UE 110, including the processing of outgoing and incoming signals to and from the AP 120 based on software code stored in the UE's memory (MEM) 110c. Analogously, the AP 120 includes (i) a wireless transceiver 120a for transmitting and receiving wireless signals to and from the UE 110, (ii) a backend transceiver 120b for transmitting and receiving (wired or wireless, depending on the implementation) signals to and from the backend communication system (not shown), and (iii) one or more processors 120c for controlling the operations of the AP 120, including the processing of outgoing and incoming signals to and from the UE 110 and the backend communication system based on software code stored in the AP's memory 120d.

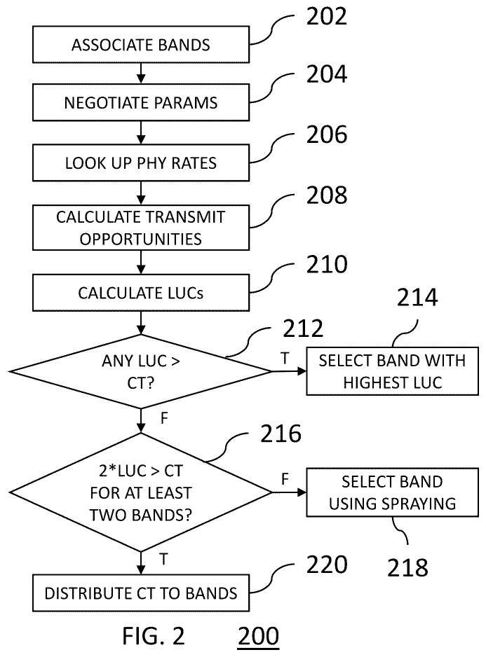

FIG. 2 is a flow diagram of the processing 200 performed by the AP 120 of FIG. 1 for the UE 110 according to certain embodiments. Note that the AP 120 independently performs the processing 200 of FIG. 2 for each associated UE that can operate in eMLSR mode for a given number n of two or more bands L1, L2, . . . , Ln, where different UEs may be able to operate with different number of bands and/or different sets of bands.

The processing 200 of FIG. 2 begins at step 202 with the AP 120 associating the UE 110 to the bands L1, L2, . . . , Ln. In step 204, for each associated band LN, where N=1, 2, . . . n, the AP 120 negotiates with the UE 110 to determine parameters, i.e., bandwidth, guard interval, and modulation coding scheme (MCS), for communications in that band LN.

In step 206, for each band LN, based on the corresponding negotiated bandwidth, guard interval, and MCS, the AP 120 retrieves a physical-layer rate (PHY) from the MCS index lookup table uploaded onto the AP. The MCS index look-up table is a well-established PHY rate table that can be hardcoded into the router's memory.

When there is (either upstream or downstream) traffic to be transmitted in a communication session between the UE 110 and the AP 120, in step 208, for each band LN, the AP 120 calculates a transmit opportunity (TO) by subtracting the current value of the on-channel utilization for the band from the band's total MAC (media access control) link capacity. Every chipset calculates these values as part of their Phy layer parameter. On-channel utilization is calculated by the chipset and used to calculate transmit opportunity as (1-On-channel utilization).

In step 210, for each band LN, the AP 120 calculates the link usage capacity (LUC) values using the following formula:

$$LUC = {TO}^{*} {PME}^{*} PHY / 100 ,$$

where PME (PHY-to-MAC Efficiency) compares the actual throughput available at the MAC layer to the PHY-layer rate. PME is specific to the chipset. Based on each chipset, the value of PME is a static approximation for that chipset, which can come from the chipset manufacturer or OEMs). The multiplication of PME and PHY is to obtain MAC throughput. PHY is known based on the radio capacity, PME is implementation capacity, and actual MAC throughput is calculated by multiplying them. PHY is tabulated from the MCS index lookup table.

In step 212, the AP 120 compares the LUC value for each band to the amount of client traffic (CT) to be transmitted in the instant communication session. CT is the chunk of ingress traffic destined for a particular router. This methodology is more applicable to AP downstream traffic. If the LUC value is greater than CT for any one or more bands, then, in step 214, the AP 120 selects the band with the greatest LUC value for the instant communication session for single link operation (SLO), where the same band/link is used for both downstream and upstream traffic, and the processing 200 is then completed for the instant communication session. For a two-band UE (i.e., L1 and L2), the logic processing of step 212 is ((LUC (L1)>CT) or (LUC (L2)>CT)). Otherwise, the processing 200 proceeds to step 216.

In step 216, the AP 120 compares two times the LUC values for each of the bands to CT. If those values are not greater than CT for at least two bands, then, in step 218, the AP 120 employs conventional spraying to select the band for the instant communication session, and the processing 200 is then completed for the instant communication session. Otherwise, the processing 200 proceeds to step 220, where the AP 120 distributes the traffic proportionately among the two or more different bands that do satisfy the condition of step 216, and the processing 200 is then completed for the instant communication session. For a two-band UE (i.e., L1 and L2), the logic processing of step 216 is ((2*LUC (L1)>CT) and (2*LUC (L2))>CT)). The distribution here refers to the AP opportunistically putting the traffic in different links one at a time to make sure that the traffic won't be put in the queue which would be the case if the traffic is sent through the link that is <CT.

Note that, in typical operations, the operations of steps 202-206 will be performed once for the UE 110, while the operations associated with steps 208-220 will be performed every time there is to be another communication session between the UE 110 and the AP 120.

Assume, for example, a two-band situation in which CT is 500 Mbps, LUC (L1) is 400 Mbps, and LUC (L2) is 300 Mbps. In that case, neither LUC (L1) nor LUC (L2) is greater than CT. As such, comparison step 212 returns a negative result and processing 200 proceeds to comparison step 216, which returns a positive result because both (2*LUC (L1)) and (2*LUC (L2)) are greater than CT. In that case, in step 220, the AP 120 proportionately and sequentially distributes CT to the bands with (LUC (L1)/(LUC (L1)+LUC (L2))*LUC (L1)=(400/700)*400=229 Mbps being assigned to band L1 and (LUC (L2)/(LUC (L1)+LUC (L2))*LUC (L2)=(300/700)*300=129 Mpbs being assigned to band L2, such that a total of about 358 Mbps get allocated to the two bands.

Although the disclosure has been described in the context of techniques performed by the AP of a WiFi network, those skilled in the art will understand that some or all of the processing for those techniques may be performed by the WiFi network's backend infrastructure. As used in the claims, the term “access point” should be interpreted as referring to the access point itself and/or the backend infrastructure.

Although the disclosure has been described in the context of APs and UEs in WiFi networks that share a common wireless environment, those skilled in the art will understand that the disclosure also applies to wireless local area networks (WLANs) that conform to standards other than a WiFi standard and to wired networks that share a common wired environment, such as a shared bus.

In certain embodiments, the present disclosure is a method for selecting a band from at least a first band and a second band for communication between an access point (AP) and an instance of user equipment (UE), the method comprising the AP (i) generating a first link usage capacity (LUC) value for the first band; (ii) generating a second LUC value for the second band; (iii) performing one or more comparisons based on the first and second LUC values to a CT value corresponding to client traffic to be communicated in a communication session between the AP and the UE; (iv) selecting the band based on the one or more comparisons; and (v) using the selected band for the communication session.

In at least some of the above embodiments, the AP generates one or more additional LUC values for one or more additional bands and performs the one or more comparisons based on the first, second, and one or more additional LUC values to the CT value.

In at least some of the above embodiments, one of the one or more comparisons comprises the AP comparing each LUC value to the CT value, and, upon determining that any of the LUC values is greater than the CT value, the AP selects the band having the greatest LUC value.

In at least some of the above embodiments, another of the one or more comparisons comprises the AP comparing two times each LUC value to the CT value; upon determining that two times the LUC values are greater than the CT value for fewer than two bands, the AP selects the band using spraying; and, upon determining that two times the LUC values are greater than the CT value for at least two bands, the AP distributes the client traffic to the at least two bands.

In at least some of the above embodiments, upon determining that two times the LUC values are greater than the CT value for the at least two bands, the AP distributes the client traffic to the at least two bands proportionately and sequentially.

In at least some of the above embodiments, the first LUC value is a function of TO, PME, and PHY, wherein TO is calculated by subtracting on-channel utilization for the first band from total media access control (MAC) link capacity for the first band; PME is PHY-to-MAC efficiency for the first band; and PHY is a rate value in a modulation and coding scheme (MCS) index lookup table based on bandwidth, guard interval, and an MCS value for the first band.

In at least some of the above embodiments, the first LUC value is proportional to TO*PME*PHY.

In at least some of the above embodiments, the AP is a Wi-Fi AP.

In at least some of the above embodiments, the first and second bands are two of 2.4 GHZ, 5 GHZ, and 6 GHz Wi-Fi bands.

In at least some of the above embodiments, the UE is an enhanced multi-link single-radio (eMLSR) UE.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A method for selecting a band from at least a first band and a second band for communication between an access point (AP) and an instance of user equipment (UE), the method comprising the AP:
generating a first link usage capacity (LUC) value for the first band;
generating a second LUC value for the second band;
performing one or more comparisons based on the first and second LUC values to a CT value corresponding to client traffic to be communicated in a communication session between the AP and the UE;
selecting the band based on the one or more comparisons; and
using the selected band for the communication session.

2. The method of claim 1, wherein the AP:
generates one or more additional LUC values for one or more additional bands; and
performs the one or more comparisons based on the first, second, and one or more additional LUC values to the CT value.

3. The method of claim 1, wherein:
one of the one or more comparisons comprises the AP comparing each LUC value to the CT value; and
upon determining that any of the LUC values is greater than the CT value, the AP selects the band having the greatest LUC value.

4. The method of claim 3, wherein:
another of the one or more comparisons comprises the AP comparing two times each LUC value to the CT value;
upon determining that two times the LUC values are greater than the CT value for fewer than two bands, the AP selects the band using spraying; and
upon determining that two times the LUC values are greater than the CT value for at least two bands, the AP distributes the client traffic to the at least two bands.

5. The method of claim 4, wherein, upon determining that two times the LUC values are greater than the CT value for the at least two bands, the AP distributes the client traffic to the at least two bands proportionately and sequentially.

6. The method of claim 1, wherein the first LUC value is a function of TO, PME, and PHY, wherein:
TO is calculated by subtracting on-channel utilization for the first band from total media access control (MAC) link capacity for the first band;
PME is PHY-to-MAC efficiency for the first band; and
PHY is a rate value in a modulation and coding scheme (MCS) index lookup table based on bandwidth, guard interval, and an MCS value for the first band.

7. The method of claim 6, wherein the first LUC value is proportional to TO*PME*PHY.

8. The method of claim 1, wherein the AP is a Wi-Fi AP.

9. The method of claim 8, wherein the first and second bands are two of 2.4 GHZ, 5 GHZ, and 6 GHz Wi-Fi bands.

10. The method of claim 1, wherein the UE is an enhanced multi-link single-radio (eMLSR) UE.

11. An access point (AP) comprising a memory and at least one processor, coupled to the memory and operative to select a band from at least a first band and a second band for communication between the AP and an instance of user equipment (UE) by the AP:
generating a first link usage capacity (LUC) value for the first band;
generating a second LUC value for the second band;
performing one or more comparisons based on the first and second LUC values to a CT value corresponding to client traffic to be communicated in a communication session between the AP and the UE;
selecting the band based on the one or more comparisons; and
using the selected band for the communication session.

12. The AP of claim 11, wherein the AP is adapted to:
generate one or more additional LUC values for one or more additional bands; and
perform the one or more comparisons based on the first, second, and one or more additional LUC values to the CT value.

13. The AP of claim 11, wherein:
one of the one or more comparisons comprises the AP comparing each LUC value to the CT value; and
upon determining that any of the LUC values is greater than the CT value, the AP is adapted to select the band having the greatest LUC value.

14. The AP of claim 13, wherein:
another of the one or more comparisons comprises the AP comparing two times each LUC value to the CT value;
upon determining that two times the LUC values are greater than the CT value for fewer than two bands, the AP is adapted to select the band using spraying; and
upon determining that two times the LUC values are greater than the CT value for at least two bands, the AP is adapted to distribute the client traffic to the at least two bands.

15. The AP of claim 14, wherein, upon determining that two times the LUC values are greater than the CT value for the at least two bands, the AP is adapted to distribute the client traffic to the at least two bands proportionately and sequentially.

16. The AP of claim 11, wherein the first LUC value is a function of TO, PME, and PHY, wherein:
TO is calculated by subtracting on-channel utilization for the first band from total media access control (MAC) link capacity for the first band;
PME is PHY-to-MAC efficiency for the first band; and
PHY is a rate value in a modulation and coding scheme (MCS) index lookup table based on bandwidth, guard interval, and an MCS value for the first band.

17. The AP of claim 16, wherein the first LUC value is proportional to TO*PME*PHY.

18. The AP of claim 11, wherein the AP is a Wi-Fi AP.

19. The AP of claim 18, wherein the first and second bands are two of 2.4 GHZ, 5 GHZ, and 6 GHz Wi-Fi bands.

20. The AP of claim 11, wherein the UE is an eMLSR UE.
